(19) United States
(12) Patent Application Publication
(10) Pub. No.: US 2005/0173833 A1
(43) Pub. Date: Aug. 11, 2005

(54) METHOD OF FORMING BIPOLAR PLATE MODULES

(76) Inventor: Dale Cummins, Paris, TN (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/708,054

(22) Filed: Feb. 5, 2004

(51) Int. Cl. B29C 31/00

(52) U.S. Cl. 264/272.11

(57) ABSTRACT

A bipolar plate module includes an anode, a cathode and a membrane electrode assembly (MEA) disposed therebetween. A sealing material forms a sealing layer between the plates and encapsulates a portion of the MEA. A method of manufacturing involves injection of the sealing material into a groove of the anode plate and through a through-hole disposed within the groove. The sealing material fills the space between the anode and cathode to form the sealing layer and encapsulates the portion of the MEA to form the edge seal. Further, material injected on the outer surface of the anode forms an insulation layer when compressed. An alternate method includes utilizing a screen printing technique to deposit the material upon the anode, placing the MEA and cathode in their proper positions, and then curing the material to form the sealing layer and to form an edge seal about the portion of the MEA.

### FIELD OF THE INVENTION

The present invention relates to methods for forming bipolar plate modules, and more particularly to methods for providing effective seals between individual fuel cell plates and an edge seal about a membrane electrode assembly (MEA).

### BACKGROUND OF THE INVENTION

It is known to apply resilient sealing beads to and between the faces of fuel cell plates for controlling fluid flows between pluralities of such plates, stacked in pairs and bolted together for generating electric power. In a typical fuel cell stack arrangement, the pluralities of such plates are sandwiched together in a parallel, face-to-face pattern. The plates are held spaced apart by resilient sealing beads typically adhesively bonded to the face of at least one of any two adjoining plates. The sealing beads fit within grooves on the faces of the plates, and define paths or channels for fluids to flow between the plates. Normally, the fluids include not only fluid electrolytes used for generation of energy, but also coolants as will be appreciated by those skilled in the art.

The fuel cell plates employed in the usual fuel cell stack are normally formed of plastic composites that include graphite. The sealing beads are formed of an elastomeric material. The beads are normally adhesively applied to the plates by a bonding agent, although in some cases the beads are simply held in place by pressure of compression created by bolted connections between plates. Each fuel cell unit is comprised of a cathode and an anode plate. Between each cathode and anode plate of each cell flows a coolant material of either glycol-based anti-freeze or deionized water. Between each fuel cell plate flows two chemically reactive elements, hydrogen and oxygen, separated by a catalytic membrane, such as a membrane electrode assembly or MEA. The hydrogen and oxygen elements react at the MEA to form water vapor in a type of reverse electrolysis.

To ensure effective operation of the fuel cell unit, the space between the anode and cathode plates, along with the space about the MEA, must be sealed to prevent leaking of the reactive elements and contamination by pollutants. The importance of an effective seal between the plates has limited manufacturer's abilities to mass-produce the fuel cell units. Additionally, factors such as cost, time and efficiency have also been a deterrent to implementation of mass-production of fuel cell units.

Accordingly, in view of these concerns, there remains a need in the industry for a method of mass-producing fuel cell units with appropriate sealing to prevent leaks and contamination.

### BRIEF SUMMARY OF THE INVENTION

A fuel cell apparatus includes a plurality of individual fuel cell units, each including at least two facing, parallel plates, mated together. A resilient sealing media, preferably formed of an elastomeric material, is employed to seal the plates together. The sealing media may be applied in the form of a curable fluid sealing material, which after being cured in place, is adapted to facilitate control of fluid flows, such as coolants between the plates, and of electrolyte flows between fuel cells.

The invention involves the method of manufacture of bipolar plate modules, each module defined by a pair of plates comprising an anode and a cathode plate. Pluralities of such modules are stacked and secured together to form commercially available composite fuel cell structures utilized to generate electric power, either domestically (i.e. for home use) or for use in vehicles.

The invention offers two alternative methods for manufacturing bipolar plate modules in a simple and efficient manner. The first method employed involves placing an anode plate, a cathode plate and a membrane electrode assembly (MEA) within a mold. The MEA is disposed between the anode and cathodes plates. A curable liquid sealing material is injected into the mold. The sealing material fills grooves formed on the anode and cathode plates to form an insulation layer. The material flows through through-holes in either the anode plate or the cathode plate and forms a sealing layer between the plates. Further, an edge seal is formed about the MEA. The sealing material is then cured to bind the anode plate to the cathode plate thereby forming the bipolar plate module.

The second alternative method of manufacturing bipolar plate modules includes screen printing a sealing material upon one of the anode or cathode plates. Next, the MEA is positioned upon the anode or cathode plate. An opposite one of the anode or cathode plate is then placed upon the MEA. Further, the sealing material is cured to form a sealing layer between the plates and an edge seal about the MEA to bind the anode plate to the cathode plate, thereby forming the bipolar plate module.

### BRIEF DESCRIPTION OF THE DRAWINGS

The present invention will now be described, by way of example, with reference to the accompanying drawings, in which:

FIG. 1 is a cross-sectional view of an assembled bipolar plate module manufactured in accordance with a first method of the present invention; and

FIG. 2 is a cross-sectional view of an assembled bipolar plate module manufactured in accordance with an alternate method of the present invention.

### DETAILED DESCRIPTION OF THE INVENTION

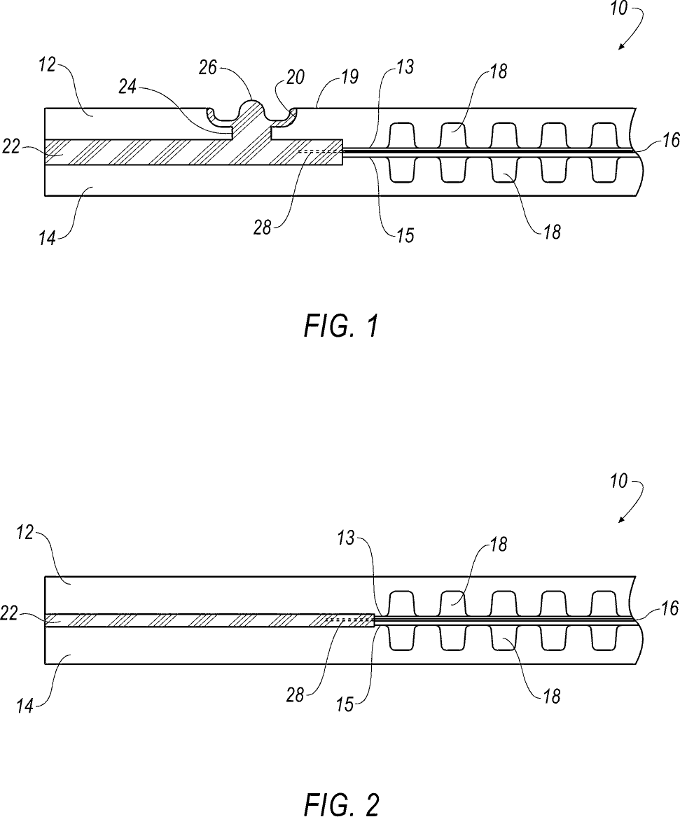

Referring to FIGS. 1 and 2, a bipolar plate module 10 is shown, which includes an anode plate 12 and a cathode plate 14. Stacks of such bipolar plate modules 10 are assembled together to provide composite fuel cell structures (not shown) to generate electric power. Disposed between each of the plates 12, 14 is a catalytic membrane or membrane electrode assembly (MEA) 16.

It will be appreciated by those skilled in the art that chemical reactions in the nature of a reverse electrolysis take place within the bipolar plate module 10. The reactions are created by the contact between the fuel components of oxygen and hydrogen, and the MEA 16 positioned between the anode plate 12 and cathode plate 14.

The anode plate 12 and cathode plate 14 include mating, parallel faces 13 and 15, respectively. The faces 13, 15 are defined by inter-plate coolant grooves 18. Primary fuel cell cooling thus takes place between each of the mated plates 12, 14 of each bipolar plate module 10. Further, referring specifically to the embodiment of FIG. 1, the anode plate 12 includes grooves 20 upon an outer surface 19.

A sealing layer 22 is interposed between each plate 12, 14. In the embodiment of FIG. 1, the sealing layer 22 extends through a through-hole 24 in the anode plate 12. Preferably, the through-hole 24 is positioned within the groove 20 of the outer surface 19 of the anode plate 12. A portion of the sealing layer 22 fills the groove 20 and forms a sealing bead 26 extending beyond the outer surface 19 of the anode plate 12. When bipolar plate modules 10 are stacked together to form the composite fuel cell structure (not shown), the sealing bead 26 is compressed and forms an insulation layer between the bipolar plate modules 10. Alternatively, although not shown in the illustrated embodiments, the cathode plate 14 may include a groove and a through-hole, similar to the groove 20 and the through-hole 24, for receiving a portion of the sealing layer 22.

Sealing layer 22 is incorporated in the bipolar plate module 10 to prevent leakage of fuel components and leakage of coolant between the plates 12, 14. Further, the sealing layer 22 prevents pollution of the bipolar plate module 10 by contaminants. Accordingly, a more effective bipolar plate module 10 results from more effective sealing between the plates 12, 14.

Further, the sealing layer 22 of each embodiment of FIGS. 1 and 2 encapsulates an end portion 28 of the MEA 16 to form an edge seal about the MEA 16. The edge seal about the MEA 16 properly orients the MEA 16 between the anode plate 12 and cathode plate 14. Additionally, the edge seal 28 prevents contaminates from entering the individual layers (not shown) of the MEA 16. Accordingly, a more effective bipolar plate module 10 results from not only more effective sealing between the plates 12, 14, but also from sealing of the end portion 28 of the MEA 16.

One method of manufacturing the bipolar plate module 10 of the present invention will now be described. Referring to the embodiment of FIG. 1, the anode and cathode plates 12, 14 are placed within a mold (not shown) The mating parallel faces 13, 15 of the plates 12, 14 are maintained in a spaced relationship and the MEA 16 is disposed therebetween. A curable liquid sealing material is then injected into the grooves 20 of the outer surface 19 of the anode plate 12 at a pressure of between about 300-700 lbs/in², which is sufficient to force the liquid material through the through-hole 24 and between the plates 12, 14. The liquid material flows into the space between the plates 12, 14 and encapsulates the end portion 28 of the MEA 16. The liquid material is then cured, typically within approximately two minutes at a temperature of between about 75-400 degrees Fahrenheit. Optionally, pressure may also be applied to cure the liquid material. When cured, the sealing layer 22 is formed between the plates 12, 14 and a portion of the sealing layer 22 fills through-hole 24 and groove 20. A sealing bead 26 is formed and extends beyond the outer surface 19 of the anode plate. Further, an edge seal is formed about the end portion 28 of the MEA 16.

The cured bipolar plate module 10 is then joined to additional bipolar plate modules 10 to form the composite fuel cell structure (not shown). Joining the modules 10 together compresses the sealing bead 26 to form an insulation layer between the modules 10 of the fuel cell unit.

Referring to FIG. 2, an alternative method of manufacturing the bipolar plate module 10 of the present invention will now be described. First, the curable, liquid sealing material is deposited upon the mating surface 13, 15 of either the anode plate 12 or cathode plate 14. Preferably, the liquid sealing material is screen-printed upon a perimeter of the anode plate 12 or cathode plate 14. Screen printing is a manufacturing technique commonly known in the art, whereby a mesh screen is masked to devise a particular shape. The liquid material flows through the non-masked portion of the screen and is deposited on the anode plate 12 or cathode plate 14. Screen printing is a faster, more precise, and more repeatable application method than conventional hand-application methods. Further, screen printing includes the ability to deposit a precise and deliberately even or uneven coating height in one printing pass.

Once the liquid sealing material is deposited on either the anode plate 12 or cathode plate 14, the MEA 16 is positioned upon the anode plate 12 or cathode plate 14. Alternatively, the MEA 16 may already be positioned upon the anode plate 12 or cathode plate 14 before the liquid material is deposited via the screen printing process. Next, the opposite plate is placed upon the MEA 16. The liquid sealing material is cured to form a sealing layer 22 between the plates 12, 14. The sealing layer 22 encapsulates the end portion 28 of the MEA 16 to form an edge seal. The liquid material is typically cured within approximately two minutes at a temperature of between about 75-400 degrees Fahrenheit. Optionally, pressure may also be applied to cure the liquid material.

As described above, the bipolar plate module 10 is stacked with other bipolar plate modules 10 to form the composite fuel cell structure (not shown). Preferably, the sealing bead 26 also forms an insulation layer that is disposed between the bipolar plate modules 10. Accordingly, an additional step of applying liquid sealing material to an outer surface of an anode plate 12 and cathode plate 14 is contemplated. This additional step may be accomplished by any technique including injection molding, screen printing, hand-application, or the like. Further, it is preferable for the anode plate 12 and cathode plate 14 to includes grooves (not shown), similar to the grooves 20 of the embodiment of FIG. 1, for receiving the liquid sealing material to form the insulation layer. Additionally, the liquid sealing material of the insulation layer may be cured separately or along with the curing of the liquid sealing material of the sealing layer 22.

The liquid sealing material utilized in the manufacturing methods of the present invention includes a silicone material or the like. In addition, a sealing material comprising epoxy nitrile is also contemplated. However, any curable, liquid material is contemplated by the present invention. The sealing layer 22 and insulation layer (not shown) formed from the same or different liquid sealing materials must provide some degree of temperature, pressure, and chemical resistance. The sealing layer 22 and the insulation layer must be both compressible and resilient so that they can adjust to shifting positions of the anode plate 12 and cathode plate 14, as well as load variances caused by expansion or contraction of the plates 12, 14 during operation. Most importantly, the sealing layer 22 and insulation layer must maintain their seal under any and all conditions.

It is to be understood that the above description is intended to be illustrative and not limiting. Many embodiments will be apparent to those of skill in the art upon reading the above description. Therefore, the scope of the invention should be determined, not with reference to the above description, but instead with reference to the appended claims, along with the full scope of equivalents to which such claims are entitled.

1. A method of manufacturing a bipolar plate module comprising an anode plate, a cathode plate, and a membrane electrode assembly (mea) disposed between the anode plate and the cathode plate, the method steps comprising the steps of:
placing the anode plate, the cathode plate and the MEA within a mold;
injecting a sealing material into the mold, whereby the seal material fills grooves formed on the anode or cathode plates to form an insulation layer, the material flows through through-holes formed in the grooves of either the anode plate or the cathode plate to form a sealing layer between the plates and to form an edge seal about a portion of the MEA; and
curing the sealing material to bind the anode plate to the cathode plate, thereby forming a bipolar plate module.

2. A method of manufacturing a bipolar plate module according to claim 1, wherein the sealing material comprises a silicone material.

3. A method of manufacturing a bipolar plate module according to claim 1, wherein the sealing material is epoxy nitrile.

4. A method of manufacturing a bipolar plate module according to claim 1, wherein the pressure for injecting the sealing material is between about 300-700 lb/in².

5. A method of manufacturing a bipolar plate module according to claim 1, wherein said temperature of the sealing material when injected into the mold is between about 75-400 degrees Fahrenheit.

6. A method of manufacturing a bipolar plate module according to claim 1, wherein said curing step includes applying pressure to the anode and cathode plates.

7. A method of manufacturing a bipolar plate module comprising an anode plate, a cathode plate, and a membrane electrode assembly (MEA) disposed between the anode plate and the cathode plate, the method comprising the steps of:
screen printing a sealing material upon one of a anode plate and a cathode plate;
positioning the MEA upon one of the anode plate and the cathode plate;
placing the other one of the anode plate and cathode plate upon the MEA;
curing the sealing material to form a sealing layer between the anode and cathode plates and to form an edge seal about a portion of the MEA, thereby binding the anode plate to the cathode plate to form a bipolar plate module.

8. A method of manufacturing a bipolar plate module according to claim 7, wherein the sealing material is deposited upon a perimeter of the anode or cathode plate.

9. A method of manufacturing a bipolar plate module according to claim 7, wherein the sealing material comprises a silicone material.

10. A method of manufacturing a bipolar plate module according to claim 7, wherein the sealing material is epoxy nitrile.

11. A method of manufacturing a bipolar plate module according to claim 7, wherein the step of positioning the MEA upon one of the anode plate and the cathode plate is performed before said screen-printing step.

12. A method of manufacturing a bipolar plate module according to claim 7, further including the step of forming an insulation layer between two bipolar plate modules.

13. A method of manufacturing a bipolar plate module according to claim 12, wherein the sealing material fills grooves formed on the anode plate and cathode plate to form the insulation layer.

14. A method of manufacturing a bipolar plate module according to claim 7, wherein said curing step includes applying pressure to the anode and cathode plates.
